(19) United States
(12) Patent Application Publication
(10) Pub. No.: US 2020/0141012 A1
(43) Pub. Date: May 7, 2020

(54) Multi-Tank Hydrogen-Oxygen Separation Reactor

(71) Applicant: Ching-Chung Tsai, Kaohsiung City (TW)

(72) Inventors: Ching-Chung Tsai, Kaohsiung City (TW); Shin-Chi Tsai, Kaohsiung City (TW); Shin-Hao Tsai, Kaohsiung City (TW)

(21) Appl. No.: 16/674,656

(22) Filed: Nov. 5, 2019

(30) Foreign Application Priority Data
Nov. 6, 2018 (TW) 107215081

(51) Int. Cl. C25B 1/04; B01J 19/24; C25B 9/18; C25B 15/08; B01J 19/00

(52) U.S. Cl. CPC C25B 1/04; B01J 19/242; B01J 19/002; C25B 15/08; C25B 9/18

(57) ABSTRACT

A multi-tank hydrogen-oxygen separation reactor is provided, including at least two hydrogen-oxygen separation reactors, and each of the hydrogen-oxygen separation reactors including an outer tank, an inner tank, a plurality of connection holes, an electrolytic solution, a first support portion, a first electrode, a first vent pipe, a second support portion, a second electrode, and a second vent pipe. The multi-tank hydrogen-oxygen separation reactor is able to enhance the efficiency of electrolyzing hydrogen and oxygen effectively and avoid explosion when hydrogen and oxygen coexist.

### CROSS-REFERENCE TO RELATED APPLICATION

This application claims priority from Taiwan Patent Application No. 107215081, filed on Nov. 6, 2018, in the Taiwan Intellectual Property Office, the content of which is hereby incorporated by reference in its entirety for all purposes.

### BACKGROUND OF THE INVENTION

### 1. Field of the Invention

The present invention relates to a hydrogen-oxygen separation reactor, more particularly to a multi-tank hydrogen-oxygen separation reactor which has a plurality of reactors for the enhancement of efficiency.

### 2. Description of the Related Art

Electrolysis refers to a process of electric current flowing through an electrolytic solution to cause an oxidation-reduction reaction on a cathode and an anode. Since the electrolysis may be applied to perform various electrochemical preparations and productions, such as chlor-alkali industry, electroplating, electrolyzed water, energy storage, and the like, the electrolysis is considered to be one of the important industrial manufacturing processes.

In the meantime, owing to the advancement of technology and the rise of environmental awareness, the development of sustainable energy sources concerning low environmental pollution has drawn wide attention. Therefore, collecting hydrogen and oxygen generated by the electrolysis to store energy also has great potentiality.

Conventionally, an electrolyzer with a single tank is often used for electrolysis as an electrolyzer with a single tank has the advantages of the simplicity in the manufacturing processes, relatively mature techniques, and low costs. However, the electrolyzer with a single tank is not efficient at producing hydrogen and oxygen, thus requiring massive electric energy so as to generate a little hydrogen and oxygen. In the meantime, there may also be a risk of explosion due to the coexistence of hydrogen and oxygen.

Hence, it has become an important issue to provide a reactor able to increase the yield of hydrogen and oxygen under the condition of electric energy being the same and reduce the risk of explosion to improve the public safety factor of operators.

### SUMMARY OF THE INVENTION

In view of the aforementioned conventional problem, the present invention provides a multi-tank hydrogen-oxygen separation reactor capable of simultaneously achieving the purposes of increasing yield and reducing the risk of explosion.

According to the purposes of the present invention, a multi-tank hydrogen-oxygen separation reactor is provided, including:

at least two hydrogen-oxygen separation reactors, and each of the hydrogen-oxygen separation reactors including: an outer tank; an inner tank disposed in the outer tank; a plurality of connection holes disposed on the inner tank to connect the outer tank and the inner tank; an electrolytic solution flowing between the outer tank and the inner tank at a height of a preset water line through the plurality of connection holes; a first support portion disposed in the outer tank and disposed outside the inner tank; a first electrode disposed on the first support portion and disposed under the preset water line; a first vent pipe disposed in the outer tank and disposed outside the inner tank and a gas-collecting end of the first vent pipe being higher than the preset water line to collect gas generated by the electrolytic solution electrolyzed by the first electrode; a second support portion disposed on the inner tank; a second electrode disposed on the second support portion and disposed under the preset water line; and a second vent pipe disposed on the inner tank and a gas-collecting end of the second vent pipe being higher than the preset water line to collect gas generated by the electrolytic solution electrolyzed by the second electrode; wherein each of the first electrodes is one of a cathode or an anode and each of the second electrodes corresponds to another of the cathode or the cathode of each of the first electrodes; wherein each of the first vent pipes is connected to a first gas storage tank; wherein each of the second vent pipes is connected to a second gas storage tank.

Preferably, when the multi-tank hydrogen-oxygen separation reactor includes n hydrogen-oxygen separation reactors, a value of total internal resistance of the multi-tank hydrogen-oxygen separation reactor is less than 6n ohm.

Preferably, a distance between each of the first electrodes and each of the second electrodes is less than one-half of a width of the outer tank.

Preferably, side cross-sectional areas of each of the first electrodes and each of the second electrodes are greater than or equal to one-half of a side surface area of the outer tank.

Preferably, materials of each of the first electrodes and each of the second electrodes are independently selected from a group consisting of gold, platinum, lead, nickel, and stainless steel.

Preferably, the electrolytic solution includes water, sulfuric acid, copper sulfate, sodium hydroxide, or any combination thereof.

Preferably, the electrolytic solution is sulfuric acid and water, and a volume ratio of sulfuric acid to water is 10:4 to 10:6.

Preferably, the multi-tank hydrogen-oxygen separation reactor further includes a monitor which issues an alert when a liquid height of the electrolytic solution is lower than one-third of the height of the preset water line.

Preferably, the multi-tank hydrogen-oxygen separation reactor further includes a water-replenishing apparatus which replenishes the electrolytic solution to the preset water line when the monitor issues an alert.

The multi-tank hydrogen-oxygen separation reactor of the present invention has the following advantages:

(1) The shorter distance is between the first electrode and the second electrode of the present invention, the short distance will be required for electron mobility, thus effectively decreasing the value of the total internal resistance of the present invention. Furthermore, owing to the large cross-sectional areas of the first electrode and the second electrode of the present invention, the area of receiving free ions is correspondingly large, thus effectively reducing the value of the total internal resistance. In the meantime, the first electrode and the second electrode of the present invention are selected from an inert electrode hardly having resistance, thereby lowering the total internal resistance. In addition, the electrolytic solution of the present invention is capable of having the adjustment of the electrolytic solution composition according to the parameters, such as the distance between electrodes, cross-sectional areas of electrodes, materials for electrode, and the like, thus making the value of the resistance of the electrolytic solution close to zero. Therefore, the multi-tank hydrogen-oxygen separation reactor of the present invention is capable of making the value of the total internal resistance of the multi-tank hydrogen-oxygen separation reactor less than the value of the total internal resistance of the electrolyzer with a separate tank with the same total volume through adjusting the total internal resistance of the multi-tank hydrogen-oxygen separation reactor, thus achieving the purpose of enhancing the efficiency of the electrolysis. As far as a person of ordinary skill in the art is concerned, the more electrolytic solution is, the better the conductivity will be. Additionally, tank resistances may be categorized into static resistance and dynamic resistance. The static resistance is the tank resistance when no power is applied, whereas the dynamic resistance is the tank resistance when power is applied. The multi-tank hydrogen-oxygen separation reactor of the present invention may be full of electric ions after the power is applied, thus having excellent conductivity and making the value of the resistance close to zero. Accordingly, multi-tank hydrogen-oxygen separation reactor of the present invention may still require to consume energy, with less energy consumption and higher gas production, however.

(2) Since the multi-tank hydrogen-oxygen separation reactor of the present invention has an inner-outer structure of the outer tank and inner tank, the present invention has the advantages of conveniently collecting gas, easily changing one single electrode when an electrode is damaged, and the like. Considering the inner-outer structure of the present invention, the problem of the first electrode and the second electrode making contact with each other due to collision may be prevented when carried on a user.

(3) The multi-tank hydrogen-oxygen separation reactor of the present invention has vent pipes and gas storage tanks. Therefore, hydrogen and oxygen generated after the electrolysis may respectively be stored, preventing the risk of explosion due to the coexistence of hydrogen and oxygen, further securing the safety of operators.

(4) Considering the monitor and the water-replenishing apparatus of the multi-tank hydrogen-oxygen separation reactor of the present invention, the monitor may issue an alert according to the height of the preset water line after the electrolysis for a period of time. Furthermore, by using the water-replenishing apparatus for the electrolytic solution replenishment, the multi-tank hydrogen-oxygen separation reactor of the present invention may be well managed.

### BRIEF DESCRIPTION OF THE DRAWINGS

FIG. 1 depicts a structural schematic diagram of one embodiment of the multi-tank hydrogen-oxygen separation reactor according to the present invention;

FIG. 2 depicts a structural schematic diagram of one embodiment of the multi-tank hydrogen-oxygen separation reactor according to the present invention;

FIG. 3 depicts a schematic diagram of the electrolysis of one embodiment of the multi-tank hydrogen-oxygen separation reactor according to the present invention; and

FIG. 4 depicts a schematic diagram of the electrolysis of one embodiment of the multi-tank hydrogen-oxygen separation reactor according to the present invention.

### DESCRIPTION OF THE PREFERRED EMBODIMENTS

To facilitate the review of the technical features, contents, advantages, and achievable effects of the present invention, the embodiments together with the drawings are described in detail as follows. However, the drawings are used only for the purpose of indicating and supporting the specification, which is not necessarily the real proportion and precise configuration after the implementation of the present invention. Therefore, the relations of the proportion and configuration of the attached drawings should not be interpreted to limit the actual scope of implementation of the present invention. For ease of understanding, the same elements in the following embodiments are explained in accordance with the same symbols.

In the description of the present invention, it should be noted that the terms “connected to”, “disposed in/on”, and the like, unless specified or defined additionally, should be considered to be a general understanding. For instance, the terms may be used to describe when elements are connected in a fixed connection, a detachable connection, or an integral connection; the elements may also be directly connected, indirectly connected through an intermediate element, or internally connected between the two elements. For a person of ordinary skill in the art, the specific meanings of the aforementioned terms in the present invention may be specifically understood.

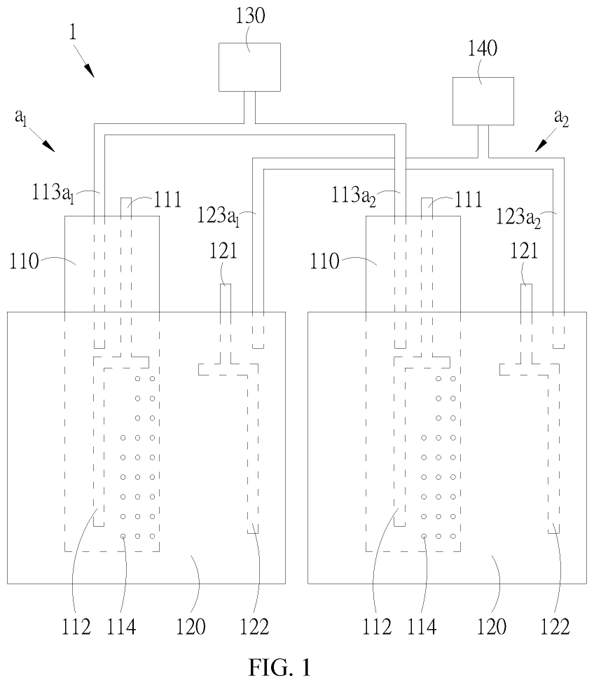

FIG. 1 depicts a structural schematic diagram of one embodiment of the multi-tank hydrogen-oxygen separation reactor according to the present invention.

As shown, in one embodiment, the multi-tank hydrogen-oxygen separation reactor 1 may include at least two hydrogen-oxygen separation reactors a1 and a2. The hydrogen-oxygen separation reactor a1 may include an outer tank 120, an inner tank 110, a plurality of connection holes 114, electrolytic solution, a first support portion 111, a first electrode 112, a first vent pipe 113a1, a second support portion 121, a second electrode 122, and a second vent pipe 123a1.

In one embodiment, the inner tank 110 is disposed in the outer tank 120. The upper portion of the inner tank 110 may protrude from the outer tank 120. In one embodiment, the material of the outer tank 120 and the inner tank 110 may be selected from conventional solid insulating materials known to a person of ordinary skill in the art, thus effectively preventing the psychical contact between the first electrode 112 and the second electrode 122. In one embodiment, the outer tank 120 and the inner tank 110 may be in the shape of a bottle, a cube, a cuboid or an irregular polyhedron.

In one embodiment, the plurality of connection holes 114 are disposed on the inner tank 110 to connect the outer tank 120 and the inner tank 110, which makes the electrolytic solution flow between the outer tank 120 and the inner tank 110 at a height of a preset water line through the plurality of connection holes 114. In one embodiment, the plurality of connection holes 114 is concentrated disposed at a height which is lower than the preset water line to improve the flow of the electrolytic solution.

In one embodiment, the first support portion 111 is disposed in the outer tank 120 and disposed outside the inner tank 110. The first electrode 112 is disposed on the first support portion 111 and disposed under the preset water line to make the first electrode 112 fully soaked in the electrolytic solution so as to enhance the efficiency of the electrolysis.

In one embodiment, the first vent pipe 113a₁ is disposed in the outer tank 120 and disposed outside the inner tank 110. The gas-collecting end of the first vent pipe 113a₁ is higher than the preset water line to collect the first electrode 112 so as to electrolyze the gas generated by the electrolytic solution and, in the meantime, prevent absorbing the electrolytic solution. In one embodiment, the first vent pipe 113a₁ is disposed adjacent to the first electrode 112 for the instant collection of the gas generated after the electrolysis of the first electrode 112.

In one embodiment, the second support portion 121 is disposed on the inner tank 110. The second electrode 122 is disposed on the second support portion 121 and disposed under the preset water line to make the second electrode 122 fully soaked in the electrolytic solution so as to enhance the efficiency of the electrolysis.

In one embodiment, the second vent pipe 123a₁ is disposed on the inner tank 110. The gas-collecting end of the second vent pipe 112a₁ is higher than the preset water line to collect the gas generated by the electrolytic solution electrolyzed by the second electrode and, in the meantime, prevent absorbing the electrolytic solution. In one embodiment, the second vent pipe 123a₁ is disposed adjacent to the second electrode 112 for the instant collection of the gas generated by the electrolysis of the second electrode 122.

In one embodiment, each of the first electrodes 112 is one of a cathode or an anode and each of the second electrodes 122 corresponds to another of the cathode or the cathode of each of the first electrodes 112. That is, when each of the first electrodes 112 is an anode, each of the second electrodes 122 is a cathode, whereas when each of the first electrodes 112 is a cathode, each of the second electrodes 122 is an anode. In one embodiment, each of the support portions 111 and each of the support portions 121 are conductive materials. In one embodiment, each of the support portions 111 connecting each of the first electrodes 112 and each of the support portions 121 connecting each of the second electrodes 122 may have physical contact in order to conduct and connect in series each of the hydrogen-oxygen separation reactors.

In a preferred aspect, when the outer tank 120 is a cuboid, the distance between each of the first electrodes 112 and each of the second electrodes 122 may be less than one-half of a width of the outer tank 123; the side cross-sectional areas of each of the first electrodes 112 and each of the second electrodes 122 may be greater than or equal to one-half of the side surface area of the outer tank 120, thus reducing the value of the total internal resistance by a way of decreasing the distance between electrodes and increasing the reaction area.

In a preferred aspect, when the outer tank 120 is in a shape of a cylindrical bottle, the distance between the first electrode 112 and the second electrode 122 may be less than one-half of the diameter of the outer tank 120; furthermore, the side cross-sectional area of the first electrode 112 and the second electrode 122 may be greater than or equal to one-sixth of the side surface area of the outer tank 120, thus reducing the value of the total internal resistance by a way of decreasing the distance between electrodes and increasing the reaction area.

In one embodiment, materials of each of the first electrodes 112 and each of the second electrodes 122 are independently selected from a group consisting of gold, platinum, lead, nickel, and stainless steel. In a preferred embodiment, the materials of the first electrode 112 and the second electrode 122 are stainless steel, thus further reducing the value of the total internal resistance. In one embodiment, when the multi-tank hydrogen-oxygen separation reactor includes n hydrogen-oxygen separation reactors, the total value of the internal resistance of the multi-tank hydrogen-oxygen separation reactor is less than 20n ohm. More preferably, the total internal resistance may be less than 10n ohms; yet more preferably, the total internal resistance may be less than 6n ohms.

In one embodiment, the electrolytic solution includes water, sulfuric acid, copper sulfate, sodium hydroxide, or any combination thereof. In a preferred embodiment, the electrolytic solution is a mixed solution of pure water obtained from reverse osmosis and sulfuric acid, and the volume ratio of sulfuric acid to water may be 10:4 to 10:6, more preferably 10:4.5 to 10:5, thus making the resistance value of the electrolytic solution measured by the ammeter close to zero.

Since the structure of the hydrogen-oxygen separation reactor a₂ is similar to that of the hydrogen-oxygen separation reactor a₁, the description regarding the similarities thereof may be omitted.

In one embodiment, the hydrogen-oxygen separation reactor a₁ and the hydrogen-oxygen separation reactor a₂ may be connected according to various aspects. In one embodiment, the first vent pipe 113a₁ and the first vent pipe 113a₂ are connected to each other and connected to the first gas storage tank 130, and the second vent pipe 123a₁ and the second vent pipe 123a₂ are connected to each other and connected to the second gas storage tank 140. Thus, this may effectively and independently store the gas generated after the electrolysis, thus achieving the purpose of avoiding explosion when hydrogen and oxygen coexist.

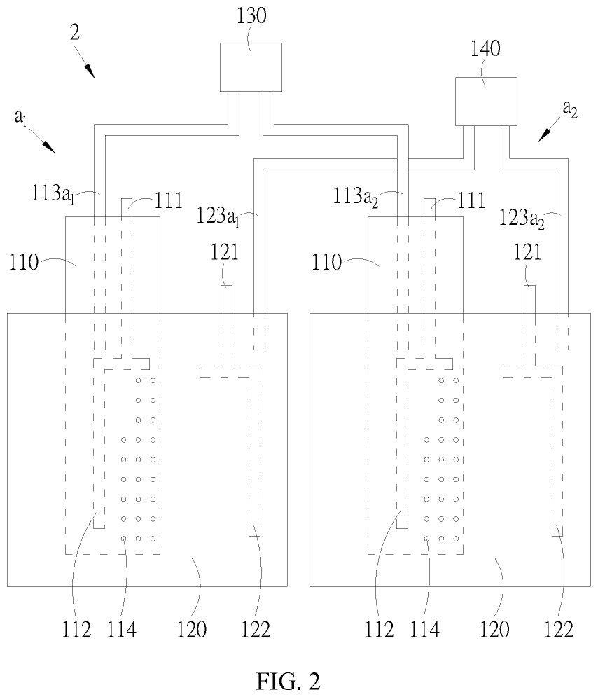

FIG. 2 depicts a structural schematic diagram of one embodiment of the multi-tank hydrogen-oxygen separation reactor according to the present invention. Since the structure of the multi-tank hydrogen-oxygen separation reactor 2 is similar to that of the multi-tank hydrogen-oxygen separation reactor 1, the description regarding the similarities thereof may be omitted.

As shown, the first vent pipe 113a₁ and the first vent pipe 113a₂ may be directly connected to the first gas storage tank 130, and the second vent pipe 123a₁ and the second vent pipe 123a₂ may be directly connected to the second gas storage tank 140. Thus, this may prevent the problem of the gas purity collected when any of the multi-tank hydrogen-oxygen separation reactors in the multi-tank hydrogen-oxygen separation reactor 2 malfunctions, and immediately collect the gas generated by the electrolysis.

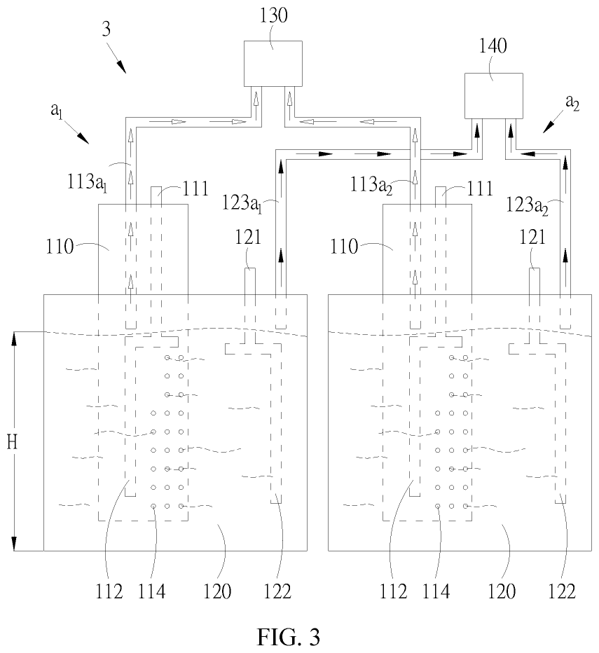

FIG. 3 depicts a schematic diagram of the electrolysis of one embodiment of the multi-tank hydrogen-oxygen separation reactor according to the present invention. Since the structure of the multi-tank hydrogen-oxygen separation reactor 3 is similar to that of the multi-tank hydrogen-oxygen separation reactor 1, the description regarding the similarities thereof may be omitted.

As shown, in one embodiment, the electrolytic solution flows between the outer tanks 120 through a plurality of connection holes 114 at a height H of a preset water line. The liquid height of the electrolytic solution gradually decreases with the time for electrolysis. In one embodiment, the monitor issues an alert to notify the crew when a liquid height of the electrolytic solution is lower than one-third of the height H of the preset water line. In one embodiment, when the monitor issues an alert, the first electrode 112 and the second electrode 122 may completely soak in the electrolytic solution to improve the efficiency of the electrolysis by a water-replenishing apparatus replenishing the electrolytic solution to the height H of the preset water line.

In one embodiment, sulfuric acid and water with a volume ratio of 10:4.7 are selected as the electrolytic solution and the electrolytic solution is added to the height H of the preset water line as 15 cm; in the meantime, the first electrode 112 is used as a cathode and the second electrode 122 is used as an anode for electrolysis. Therefore, as indicated by the hollow arrow, hydrogen generated by the first electrode 112 is collected to the first gas storage tank 130; as indicated by the solid arrow, oxygen generated by the second electrode 122 is collected to the second gas storage tank 140. As the time of electrolysis is lengthened, when the liquid height of the electrolytic solution is below 5 cm, the monitor may issue an alert and replenish the electrolytic solution to 15 cm by the water-replenishing apparatus.

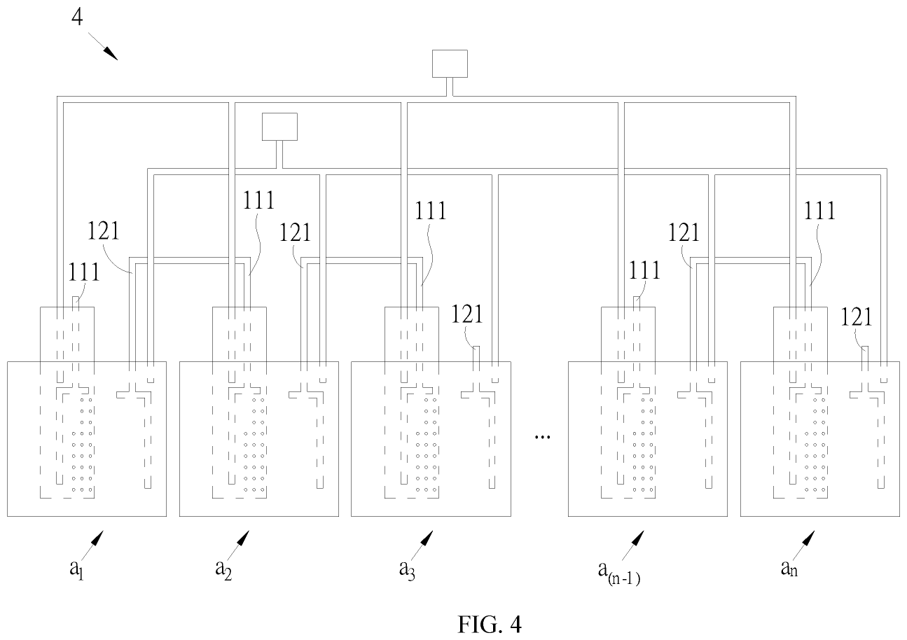

FIG. 4 depicts a schematic diagram of the electrolysis of one embodiment of the multi-tank hydrogen-oxygen separation reactor according to the present invention. Since the structure of the multi-tank hydrogen-oxygen separation reactor 4 is similar to that of the multi-tank hydrogen-oxygen separation reactor 1, the description regarding the similarities thereof may be omitted.

As shown, in one embodiment, the multi-tank hydrogen-oxygen separation reactor 4 is a multi-tank hydrogen-oxygen separation reactor 4 in which n hydrogen-oxygen separation reactors a1 to aₙ are connected in series. Specifically, the second support portion 121 of the hydrogen-oxygen separation reactor a₁ and the first support portion 111 of the hydrogen-oxygen separation reactor a₂ physically make contact with each other to electrically conduct each other; the second support portion 121 of the hydrogen-oxygen separation reactor a₂ physically make contact with the first support portion 111 of the hydrogen-oxygen separation reactor a₃ to electrically conduct each other, and so on and so forth. The second support portion 121 of the hydrogen-oxygen separation reactor a₍ₙ₋₁₎ and the first support portion 111 of the hydrogen-oxygen separation reactor aₙ physically make contact with each other to electrically conduct each other. In the meantime, if the first support portion 111 of the hydrogen-oxygen separation reactor a₁ is connected to the positive charge, the second support portion 121 of the hydrogen-oxygen separation reactor aₙ is connected to a negative charge. Hence, the multi-tank hydrogen-oxygen separation reactor of the present invention may be connected in series with any number of hydrogen-oxygen separation reactors. Moreover, through adjusting the distance between electrodes, the cross-sectional areas of the electrodes, materials for electrodes, and the component of the electrolytic solution, the resistance between each of the first electrodes and each of the second electrodes of each of the hydrogen-oxygen separation reactors is zero or close to zero.

To conclude, the multi-tank hydrogen-oxygen separation reactor of the present invention may simultaneously achieve the purposes of saving electric energy and increasing the yield of hydrogen and oxygen through reducing the value of the total internal resistance. In the meantime, since the multi-tank hydrogen-oxygen separation reactor of the present invention has an inner-outer structure, hydrogen and oxygen may be conveniently collected independently, thus achieving the purpose of reducing the risk of explosion.

The above description is merely illustrative rather than restrictive. Any equivalent modification or alteration without departing from the spirit and scope of the present invention should be included in the present claims.

What is claimed is:

1. A multi-tank hydrogen-oxygen separation reactor, comprising:
at least two hydrogen-oxygen separation reactors, and each of the hydrogen-oxygen separation reactors comprising:
an outer tank;
an inner tank disposed in the outer tank;
a plurality of connection holes disposed on the inner tank to connect the outer tank and the inner tank;
an electrolytic solution flowing between the outer tank and the inner tank at a height of a preset water line through the plurality of connection holes;
a first support portion disposed in the outer tank and disposed outside the inner tank;
a first electrode disposed on the first support portion and disposed under the preset water line;
a first vent pipe disposed in the outer tank and disposed outside the inner tank and a gas-collecting end of the first vent pipe being higher than the preset water line to collect gas generated by the electrolytic solution electrolyzed by the first electrode;
a second support portion disposed on the inner tank;
a second electrode disposed on the second support portion and disposed under the preset water line; and
a second vent pipe disposed on the inner tank and a gas-collecting end of the second vent pipe being higher than the preset water line to collect gas generated by the electrolytic solution electrolyzed by the second electrode;
wherein each of the first electrodes is one of a cathode or an anode and each of the second electrodes corresponds to another of the cathode or the cathode of each of the first electrodes;
wherein each of the first vent pipes is connected to a first gas storage tank;
wherein each of the second vent pipes is connected to a second gas storage tank.

2. The multi-tank hydrogen-oxygen separation reactor according to claim 1, wherein when the multi-tank hydrogen-oxygen separation reactor comprises n hydrogen-oxygen separation reactors, a value of total internal resistance of the multi-tank hydrogen-oxygen separation reactor is less than 6 n ohm.

3. The multi-tank hydrogen-oxygen separation reactor according to claim 1, wherein a distance between each of the first electrodes and each of the second electrodes is less than one half of a width of the outer tank.

4. The multi-tank hydrogen-oxygen separation reactor according to claim 1, wherein side cross-sectional areas of each of the first electrodes and each of the second electrodes are greater than or equal to one half of a side surface area of the outer tank.

5. The multi-tank hydrogen-oxygen separation reactor according to claim 1, wherein materials of each of the first electrodes and each of the second electrodes are independently selected from a group consisting of gold, platinum, lead, nickel, and stainless steel.

6. The multi-tank hydrogen-oxygen separation reactor according to claim 1, wherein the electrolytic solution comprises water, sulfuric acid, copper sulfate, sodium hydroxide, or any combination thereof.

7. The multi-tank hydrogen-oxygen separation reactor according to claim 6, wherein the electrolytic solution is sulfuric acid and water, and a volume ratio of sulfuric acid to water is 10:4 to 10:6.

8. The multi-tank hydrogen-oxygen separation reactor according to claim 1, further comprising a monitor, wherein the monitor issues an alert when a liquid height of the electrolytic solution is lower than one-third of the height of the preset water line.

9. The multi-tank hydrogen-oxygen separation reactor according to claim 8, further comprising a water-replenishing apparatus, wherein the water-replenishing apparatus replenishes the electrolytic solution to the preset water line when the monitor issues an alert.
